(19) United States
(12) Patent Application Publication
(10) Pub. No.: US 2017/0012763 A1
(43) Pub. Date: Jan. 12, 2017

(54) Multiband Filter Circuitry, Multiband Duplexer Circuitry, and Related Radio-Frequency System

(71) Applicant: MEDIATEK INC., HSIN-CHU (TW)

(72) Inventors: Min-Shou Wu, Hsinchu City (TW); Lien Chien, Hsinchu City (TW); Yi-Chun Huang, Taipei City (TW)

(21) Appl. No.: 14/793,744

(22) Filed: Jul. 8, 2015

(51) Int. Cl. H04L 5/14; H04B 1/00

(52) U.S. Cl. CPC H04L 5/1461; H04B 1/0067

(57) ABSTRACT

A multiband filter circuitry utilized in a radio-frequency (RF) system is disclosed. The multiband filter circuitry operates at a plurality of operating frequency bands. The multiband filter circuitry comprises at least a switchable-filtering series. Each of the at least a switchable-filtering series comprises a first terminal coupled between the antenna and the RF processing unit; a second terminal coupled to a ground; and a plurality of switchable-filtering units connected in series, each comprising a filtering unit; and a switching unit, connected to the filtering unit in parallel.

### BACKGROUND

The present disclosure relates to a multiband filter circuitry, a multiband duplexer circuitry and related radio-frequency systems, and more particularly, to a multiband filter circuitry, a multiband duplexer circuitry and related radio-frequency systems capable of operating at a plurality of operating frequency bands with less bill of material (BOM) list and small circuit layout area.

Modern mobile telecommunications standards continue to demand increasingly greater rates of data exchange (data rates). One way to achieve a high data rate in a mobile communication device is through the use of carrier aggregation. Carrier aggregation allows a single mobile communication device to optionally operate at a plurality of operating frequency bands and aggregate bandwidth across the operating frequency bands in the wireless spectrum. The increased bandwidth achieved, as a result of carrier aggregation, allows a mobile communication device to obtain higher data rates.

FIG. 1 is a schematic diagram of a radio-frequency (RF) system 10 for carrier aggregation according to the prior art. The RF system 10 is able to optionally operate at operating frequency bands BD_1-BD_M in a time division duplex (TDD) fashion. In order to operate at one of the operating frequency bands BD_1-BD_M, say, the operating frequency band BD_1, the RF system 10 has to comprise an amplifying unit Amp_1, a band switching unit BSW_1, filters F1-FN, and an antenna switching unit ASW_1, such that RF signals may be transmitted or received via an antenna of the RF system 10. In addition, the RF system 10 has to comprise amplifying units Amp_2-Amp_M, band switching units BSW_2-BSW_M, and antenna switching units ASW_2-ASW_M, so as to operate at the operating frequency bands BD_2-BD_M. Thus, implementing the RF system 10 requires a larger bill of material (BOM) list and a larger circuit layout area.

Similarly, for an RF system operating in a frequency division duplex (FDD) fashion, a larger bill of material (BOM) list and a larger circuit layout area are also required. For example, please refer to FIG. 2, which is a schematic diagram of an RF system 20 for carrier aggregation according to the prior art. The RF system 20 is able to optionally operate at operating frequency bands BD_1-BD_M in an FDD fashion. As shown in FIG. 2, the RF system 20 comprises duplexers DP_1-DP_M coupled between filtering modules FM and RF processing modules RFM, and antenna switching units ASW_1-ASW_M coupled between the filtering modules FM and an antenna of the RF system 20, so as to operate at the operating frequency bands BD_1-BD_M. Thus, implementing the RF system 20 also requires a larger BOM list and a larger circuit layout area.

Notably, larger BOM lists increase production cost of the mobile communication device, and larger circuit layout area brings larger insertion loss, which degrades signal transmission efficiency.

Therefore, it is necessary to improve the prior art.

### SUMMARY

It is therefore a primary objective of the present disclosure to provide a multiband filter circuitry, a multiband duplexer circuitry and related radio-frequency systems, capable of operating at a plurality of operating frequency bands with less bill of material (BOM) list and small circuit layout area.

An implementation discloses a multiband filter circuitry, utilized in a radio-frequency (RF) system, operating at a plurality of operating frequency bands, the multiband filter circuitry comprising at least a switchable-filtering series, each of the at least a switchable-filtering series comprising a first terminal, coupled between the antenna and the RF processing unit; a second terminal, coupled to a ground; a plurality of switchable-filtering units connected in series, each comprising a filtering unit; and a switching unit, connected to the filtering unit in parallel.

An implementation further discloses a multiband duplexer circuitry, utilized in an RF system, operating at a plurality of operating frequency bands, the multiband duplexer circuitry comprising a first multiband filter circuitry, coupled between an antenna and a first RF processing unit of the RF system, the first multiband filter circuitry comprising at least a first switchable-filtering series, coupled to the antenna and the first RF processing unit, each of the at least a first switchable-filtering series comprising a plurality of first switchable-filtering units connected in series; and a second multiband filter circuitry, coupled between the antenna and a second RF processing unit of the RF system, the second multiband filter circuitry comprising at least a second switchable-filtering series, coupled to the antenna and the second RF processing unit, each of the at least a second switchable- filtering series comprising a plurality of second switchable-filtering units connected in series.

An implementation further discloses an RF system, comprising an antenna; an RF processing unit; a multiband filter circuitry, operating at a plurality of operating frequency bands, the multiband filter circuitry comprising at least a switchable-filtering series, each of the at least a switchable-filtering series comprising a first terminal, coupled between the antenna and the RF processing unit; a second terminal, coupled to a ground; a plurality of switchable-filtering units connected in series, each comprising a filtering unit; and a switching unit, connected to the filtering unit in parallel.

An implementation further discloses an RF system, comprising an antenna; a first RF processing unit; a second RF processing unit; a multiband duplexer circuitry, coupled to the antenna, the first RF processing unit and the second RF processing unit, operating at a plurality of operating frequency bands, the multiband duplexer circuitry comprising a first multiband filter circuitry, coupled between the antenna and the first RF processing unit of the RF system, the first multiband filter circuitry comprising at least a first switchable-filtering series, coupled to the first antenna and the RF processing unit, each of the at least a first switchable-filtering series comprising a plurality of first switchable-filtering units connected in series; and a second multiband filter circuitry, coupled between the antenna and the second RF processing unit of the RF system, the second multiband filter circuitry comprising at least a second switchable-filtering series, coupled to the second antenna and the RF processing unit, each of the at least a second switchable- filtering series comprising a plurality of second switchable-filtering units connected in series.

These and other objectives of the present disclosure will no doubt become obvious to those of ordinary skill in the art after reading the following detailed description of the implementations that are illustrated in the various figures and drawings.

### BRIEF DESCRIPTION OF THE DRAWINGS

FIG. 1 is a schematic diagram of a radio-frequency (RF) system according to the prior art.

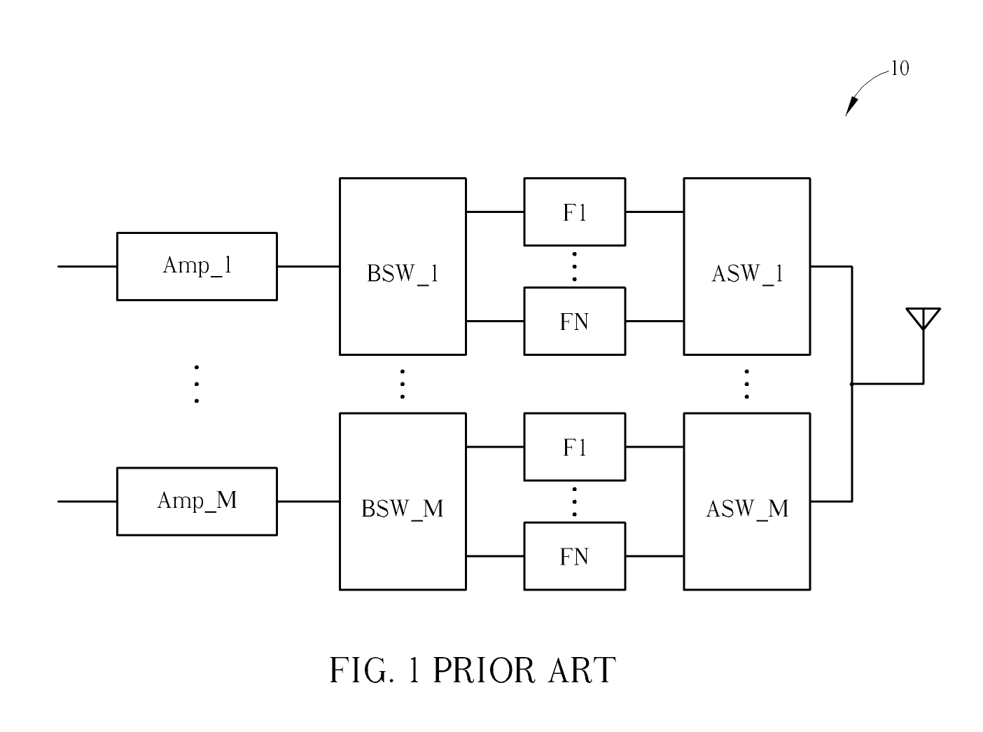

FIG. 2 is a schematic diagram of an RF system according to the prior art.

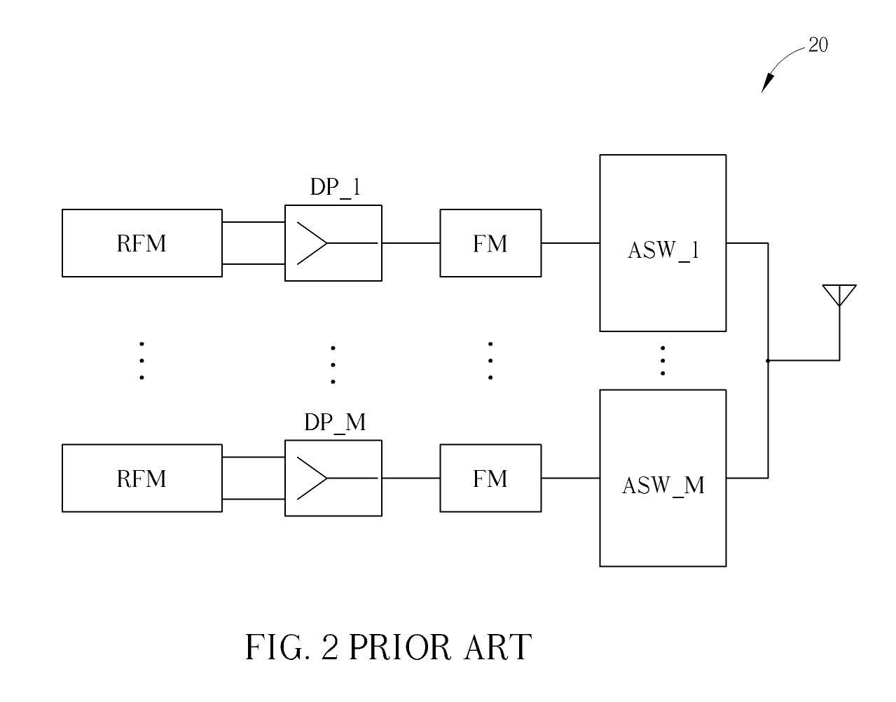

FIG. 3 is a schematic diagram of an RF system according to an implementation of the present disclosure.

FIG. 4 is a schematic diagram of operation situation of the RF system in FIG. 3.

FIG. 5 is a schematic diagram of an RF system according to an implementation of the present disclosure.

### DETAILED DESCRIPTION

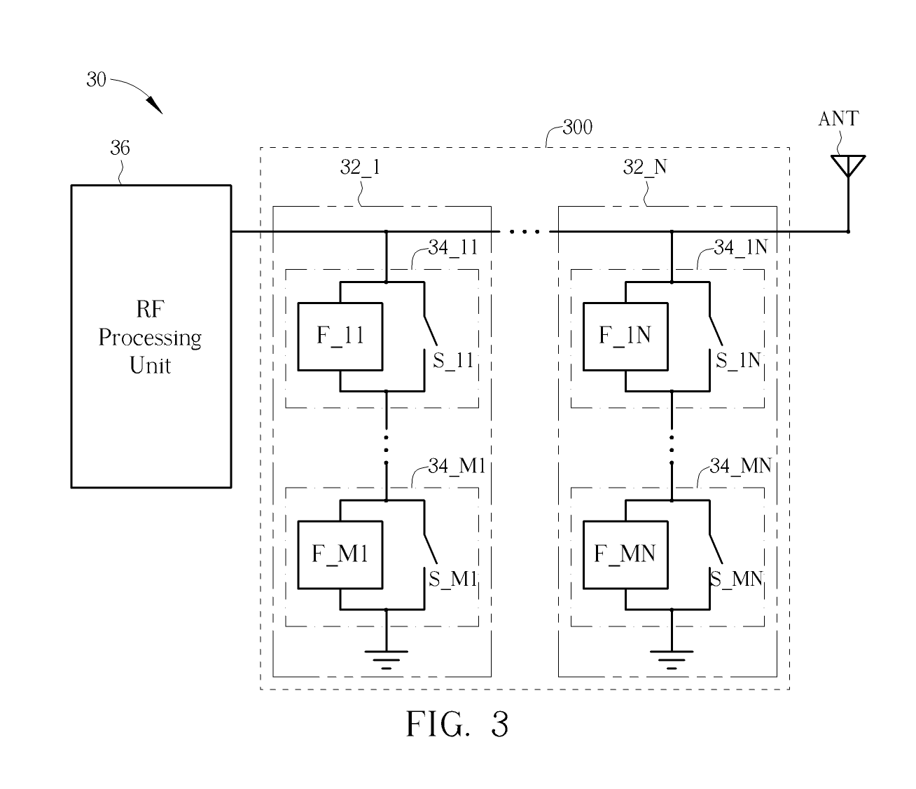

FIG. 3 is a schematic diagram of a radio-frequency (RF) system 30 according to an implementation of the present disclosure. The RF system 30 comprises an antenna ANT, an RF processing unit 36, and a multiband filter circuitry 300. The RF system 30 operates in a time division duplex (TDD) fashion, i.e., the RF system 30 delivers RF signals in a downlink (DL) direction and an uplink (UL) direction at different time. The multiband filter circuitry 300 is coupled between the antenna ANT and the RF processing unit 36. The RF system 30 and the multiband filter circuitry 300 may optionally operate at operating frequency bands BAND_1-BAND_M, wherein M stands for a number of operating frequency bands for the RF system 30. The multiband filter circuitry 300 comprises switchable-filtering series 32_1-32_N, wherein N stands for a number of switchable-filtering series comprised in the multiband filter circuitry 300. Each of the switchable-filtering series 32_1-32_N comprises M switchable-filtering units corresponding to the operating frequency bands BAND_1-BAND_M. For example, the j-th switchable-filtering series 32_j comprises switchable-filtering units 34_1j-34_Mj, wherein “j” is an integer ranging from 1 to N. Furthermore, the i-th switchable-filtering unit 34_ij within the j -th switchable-filtering series 32_j comprises a filtering unit F_ij and a switching unit S_ij connected to the filtering unit F_ij in parallel, wherein “i” is an integer ranging from 1 to M. A terminal of each switchable-filtering series is coupled between the antenna ANT and the RF processing unit 36, and another terminal of each switchable-filtering series is coupled to a ground. The filtering unit F_ij may be a resistor-inductor-capacitor (RLC) filter, a surface acoustic wave (SAW) resonator, a bulk acoustic wave (BAW) resonator, etc. The switching unit S_ij may be a single pole double throw (SPDT) switch, etc.

From another perspective, the filtering units F_i1-F_iN are corresponding to the operating frequency band BAND_i, and whether the RF system 30 operates at the operating frequency band BAND_i is controlled by on-off statuses of each switching units S_i1-S_iN connected to the filtering units F_i1-F_iN. In detail, take the filtering unit F_ij and the corresponding switching unit S_ij as an example, when the switching unit S_ij is conducted, a short circuit connecting two ends of the filtering unit F_ij is formed, which makes the filtering unit F_ij disabled. Hence, RF signals at the operating frequency band BAND_i would be filtered out by another filtering unit within the switchable-filtering series 32_j. On the other hand, when the switching unit S_ij is cutoff, the switching unit S_ij parallel to the filtering unit F_ij forms an open circuit, which makes the filtering unit F_ij enabled. Hence, RF signals at the operating frequency band BAND_i are reserved by the filtering unit F_ij. When the switching units S_i1-S_iN are conducted, the RF system 30 is not able to operate at the operating frequency band BAND_i. Otherwise, when the switching units S_i1-S_iN are cutoff, the RF system 30 may operate at the operating frequency band BAND_i. Therefore, the RF system 30 is configured to operate at the operating frequency band BAND_i by controlling the switching units S_i1-S_iN to be off; the RF system 30 is configured to not operate at the operating frequency band BAND_i by controlling the switching units S_i1-S_iN to be conducted. In short, the RF system 30 operates at the operating frequency band BAND_i when the switching units S_i1-S_iN are cutoff; the RF system 30 does not operate at the operating frequency band BAND_i when the switching units S_i1-S_iN are conducted.

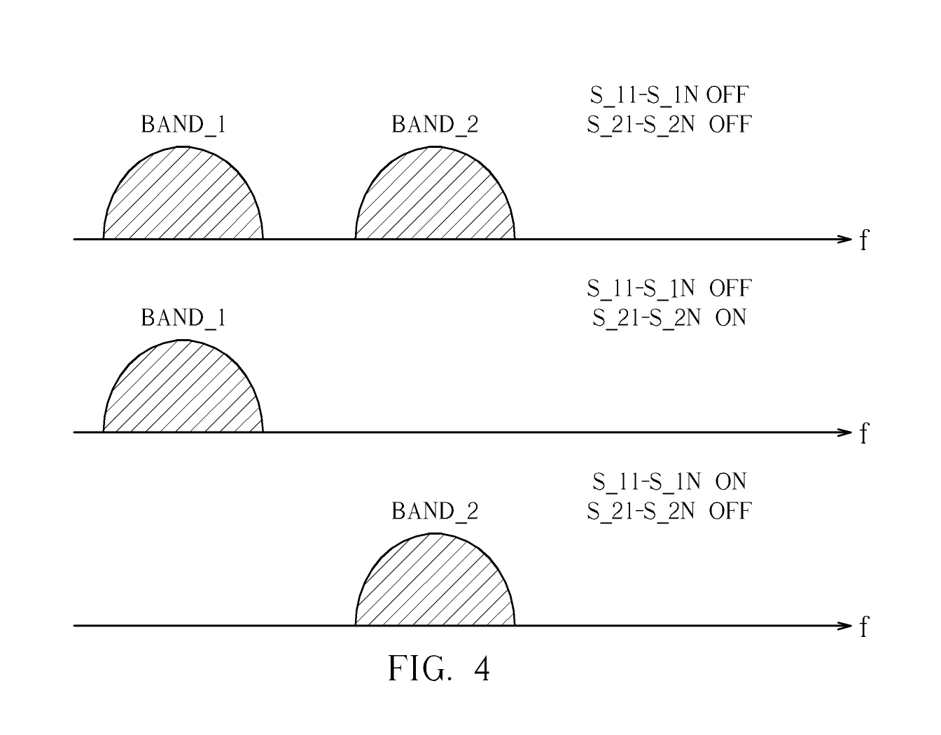

For example, please refer to FIG. 4, which is a schematic diagram of operation situations of the RF system 30. For simplicity, FIG. 4 only illustrates an optionality of the first two operating frequency bands BAND_1, BAND_2. As can be seen from FIG. 4, the RF system 30 operates both at the operating frequency bands BAND_1, BAND_2 when both of the switching units S_11-S_1N, S_21-S_2N are cutoff. The RF system 30 operates only at the operating frequency band BAND_1 when the switching units S_11-S_1N are cutoff and the switching units S_21-S_2N are conducted to be on. The RF system 30 operates only at the operating frequency band BAND_2 when the switching units S_21-S_2N are cutoff and the switching units S_11-S_1N are conducted to be on. Similar operational principles are extended for the rest operating frequency bands BAND_3-BAND_M, which are not narrated herein.

Therefore, the RF system 30 is able to optionally operate at the operating frequency bands BAND_1-BAND_M, by simply controlling the on-off statuses of the switching units, which may be utilized to perform carrier aggregation required by wireless communication systems.

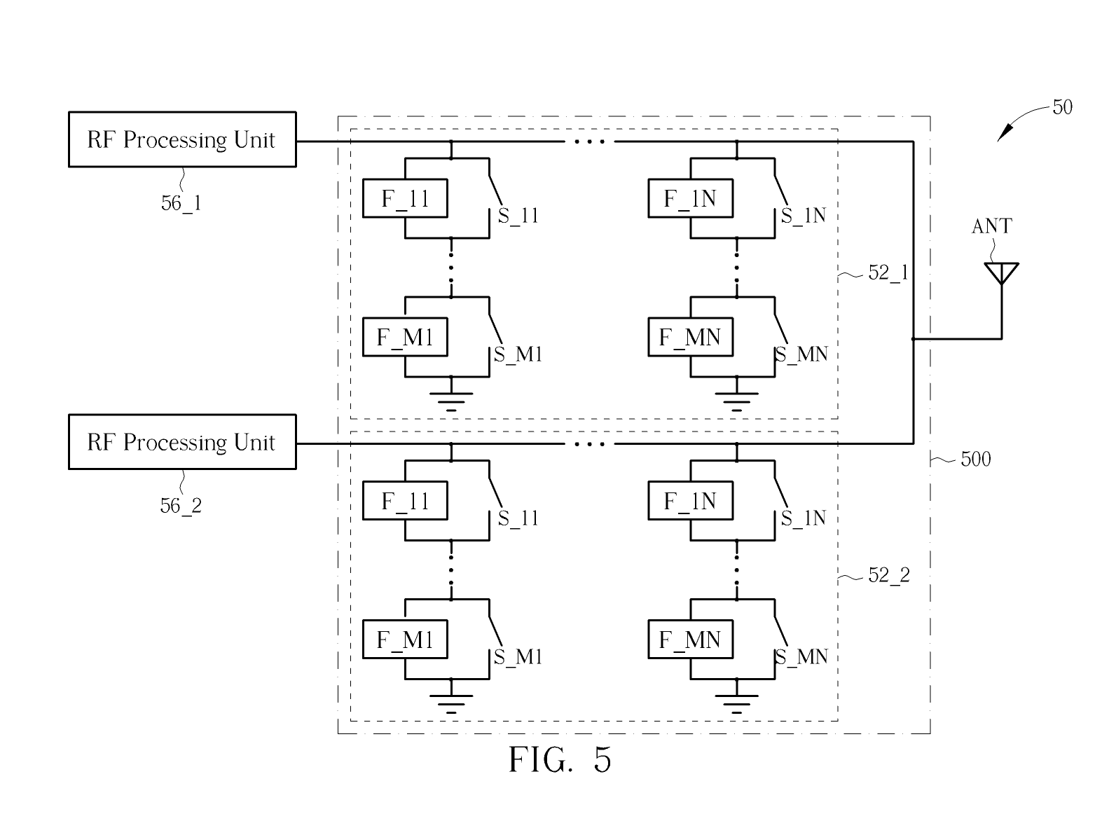

Similarly, the structure of the multiband filter circuitry 300, using the switchable- filtering series and the switching units thereof to select which operating frequency band for the RF system to operate at, may be extended to a multiband duplexer circuitry in a frequency division duplex (FDD) RF system. Please refer to FIG. 5, which is a schematic diagram of an RF system 50 according to an implementation of the present disclosure. The RF system 50 maybe applied in a mobile communication device capable of performing carrier aggregation, and operate in an FDD fashion, i.e., the RF system 50 delivers wireless signals in a DL direction and an UL direction at the same time but at different operating frequency bands. The RF system 50 comprises an antenna ANT, RF processing units 56_1, 56_2, and a multiband duplexer circuitry 500. The multiband duplexer circuitry 500 is coupled to the antenna ANT and the RF processing units 56_1, 56_2. The multiband duplexer circuitry 500 comprises multiband filter circuitries 52_1, 52_2. Each multiband filter circuitry 52_k is coupled between the antenna ANT and the RF processing unit 56_k (where k is 1 or 2). In an implementation, the RF processing unit 56_1 and the multiband filter circuitry 52_1 are in charge of RF signal in the DL direction, and the RF processing unit 56_2 and the multiband filter circuitry 52_2 are in charge of RF signal in the UL direction. The structures of the multiband filtering circuitries 52_1, 52_2 are the same as the multiband filter circuitry 300. The operational principles of the multiband filtering circuitries 52_1, 52_2 are the same as those of the multiband filter circuitry 300, which are not narrated herein for brevity.

Notably, the multiband filter circuitry 300 and the multiband duplexer circuitry 500 may be integrated into single functional modules, coupled between the RF processing unit (s) and the antenna. Hence, implementation complexity of the RF systems 30, 50 is simplified. Compared with the RF systems 10, 20 in the prior art, implementing the RF systems 30, 50 does not need such many band switching units, filters and filter modules, antenna switching units, and duplexers. Hence, the BOM lists and circuit layout area for the RF systems 30, 50 are reduced.

Notably, the implementations stated in the above are for illustrative purpose. Those skilled in the art may make modifications and alternations accordingly, and not limited herein. For example, the number of switchable-filtering unit M within each switchable-filtering series depends on system requirements, which is not limited. In addition, the number of switchable-filtering series N is not limited, which may be only 1. In other words, the multiband filter circuitry may comprise one or more switchable-filtering series. Comprising more the switchable-filtering series increases frequency selectivity of filters, and the number of switchable-filtering series may depend on system requirements.

In addition, the filtering unit F_ij, the switching unit S_ij, the multiband filter circuitry 300 and the multiband duplexer circuitry 500 may be implemented via a complementary metal-oxide-semiconductor (CMOS) process, a silicon on insulator (SOI) process, an integrated passive device (IPD) process, a high electron mobility transistor (HEMT) process, etc., and not limited herein. In addition, the multiband filter circuitry and the multiband duplexer circuitry may be integrated with impedance matching circuitries thereof into single functional modules, and thus, the integrality of the RF systems is enhanced.

In summary, the multiband filter circuitry and the multiband duplexer circuitry in the RF systems of the present disclosure may optionally operate at multiple operating frequency bands, and be utilized to perform carrier aggregation required by the wireless communication systems. Carrier aggregation is performed by simply controlling the on-off statuses of the switching units thereof. In addition, the multiband filter circuitry and the multiband duplexer circuitry may be integrated into single functional modules, such that the BOM lists and circuit layout area are reduced.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A multiband filter circuitry, utilized in a radio-frequency (RF) system, operating at a plurality of operating frequency bands, the multiband filter circuitry comprising at least a switchable-filtering series, each of the at least a switchable-filtering series comprising:
a first terminal, coupled between an antenna and an RF processing unit;
a second terminal, coupled to a ground;
a plurality of switchable-filtering units connected in series, each comprising:
a filtering unit; and
a switching unit, connected to the filtering unit in parallel.

2. The multiband filter circuitry of claim 1, wherein a first filtering unit within each switchable-filtering series is corresponding to a first operating frequency band within the plurality of operating frequency bands.

3. The multiband filter circuitry of claim 2, wherein whether the RF system operates at the first operating frequency band is controlled by an on-off status of a first switching unit connected to the first filtering unit.

4. The multiband filter circuitry of claim 3, wherein the RF system operates at the first operating frequency band when the first switching unit is cutoff.

5. The multiband filter circuitry of claim 3, wherein the RF system does not operate at the first operating frequency band when the first switching unit is conducted.

6. A multiband duplexer circuitry, utilized in a radio-frequency (RF) system, operating at a plurality of operating frequency bands, the multiband duplexer circuitry comprising:
a first multiband filter circuitry, coupled between an antenna and a first RF processing unit of the RF system, the first multiband filter circuitry comprising:
at least a first switchable-filtering series, coupled to the antenna and the first RF processing unit, each of the at least a first switchable-filtering series comprising a plurality of first switchable-filtering units connected in series; and
a second multiband filter circuitry, coupled between the antenna and a second RF processing unit of the RF system, the second multiband filter circuitry comprising:
at least a second switchable-filtering series, coupled to the antenna and the second RF processing unit, each of the at least a second switchable-filtering series comprising a plurality of second switchable-filtering units connected in series.

7. The multiband duplexer circuitry of claim 6, wherein each of the plurality of first switchable-filtering units and the plurality of second switchable-filtering units comprises:
a filtering unit; and
a switching unit, connected to the filtering unit in parallel.

8. The multiband duplexer circuitry of claim 7, wherein a first filtering unit within each of the at least a first switchable-filtering series and the at least a second switchable-filtering series is corresponding to a first operating frequency band within the plurality of operating frequency bands.

9. The multiband duplexer circuitry of claim 8, wherein whether the RF system operates at the first operating frequency band is determined by controlling an on-off status of a first switching unit connected to the first filtering unit.

10. The multiband duplexer circuitry of claim 9, wherein the RF system operates at the first operating frequency band when the first switching unit is cutoff.

11. The multiband duplexer circuitry of claim 9, wherein the RF system does not operate at the first operating frequency band when the first switching unit is conducted.

12. A radio-frequency (RF) system, comprising:
an antenna;
an RF processing unit;
a multiband filter circuitry, operating at a plurality of operating frequency bands, the multiband filter circuitry comprising at least a switchable- filtering series, each of the at least a switchable-filtering series comprising:
a first terminal, coupled between the antenna and the RF processing unit;
a second terminal, coupled to a ground;
a plurality of switchable- filtering units connected in series, each comprising:
a filtering unit; and
a switching unit, connected to the filtering unit in parallel.

13. The RF system of claim 12, wherein a first filtering unit within each switchable-filtering series is corresponding to a first operating frequency band within the plurality of operating frequency bands.

14. The RF system of claim 13, wherein whether the RF system operates at the first operating frequency band is determined by controlling an on-off status of a first switching unit connected to the first filtering unit.

15. The RF system of claim 14, wherein the RF system operates at the first operating frequency band when the first switching unit is controlled to be cutoff.

16. The RF system of claim 14, wherein the RF system does not operate at the first operating frequency band when the first switching unit is controlled to be conducted.

17. A radio-frequency (RF) system, comprising:
an antenna;
a first RF processing unit;
a second RF processing unit;
a multiband duplexer circuitry, coupled to the antenna, the first RF processing unit and the second RF processing unit, operating at a plurality of operating frequency bands, the multiband duplexer circuitry comprising:
a first multiband filter circuitry, coupled between the antenna and the first RF processing unit of the RF system, the first multiband filter circuitry comprising:
at least a first switchable-filtering series, coupled to the first antenna and the RF processing unit, each of the at least a first switchable-filtering series comprising a plurality of first switchable-filtering units connected in series; and
a second multiband filter circuitry, coupled between the antenna and the second RF processing unit of the RF system, the second multiband filter circuitry comprising:
at least a second switchable-filtering series, coupled to the second antenna and the RF processing unit, each of the at least a second switchable-filtering series comprising a plurality of second switchable-filtering units connected in series.

18. The RF system of claim 17, wherein each of the plurality of first switchable-filtering units and the plurality of second switchable-filtering units comprises:
a filtering unit; and
a switching unit, connected to the filtering unit in parallel.

19. The RF system of claim 18, wherein a first filtering unit within each of the at least a first switchable-filtering series and the at least a second switchable-filtering series is corresponding to a first operating frequency band within the plurality of operating frequency bands.

20. The RF system of claim 19, wherein whether the RF system operates at the first operating frequency band is determined by controlling an on-off status of a first switching unit connected to the first filtering unit.

21. The RF system of claim 20, wherein the RF system operates at the first operating frequency band when the first switching unit is cutoff.

22. The RF system of claim 20, wherein the RF system does not operate at the first operating frequency band when the first switching unit is conducted.
